(19) United States
(12) Patent Application Publication
(10) Pub. No.: US 2026/0043549 A1
(43) Pub. Date: Feb. 12, 2026

(54) METHOD OF OPERATING AN OVEN APPLIANCE

(71) Applicant: Haier US Appliance Solutions, Inc., Wilmington, DE (US)

(72) Inventors: Karen Marie Edberg, Louisville, KY (US); Hans Juergen Paller, Louisville, KY (US)

(21) Appl. No.: 18/799,648

(22) Filed: Aug. 9, 2024

(51) Int. Cl. F24C 3/12; G05D 23/19

(52) U.S. Cl. CPC F24C 3/128; G05D 23/1951

(57) ABSTRACT

An oven appliance includes a cooking chamber, a gas burner thermally coupled to the cooking chamber, a temperature sensor in thermal communication with the cooking chamber, and a controller in operative communication with the gas burner and the temperature sensor. The controller is configured to obtain a chamber temperature using the temperature sensor, determine that heat is needed based on the chamber temperature and a target chamber temperature, obtain a target operating time of the gas burner based on the chamber temperature and the target chamber temperature, determine that the target operating time is less than a minimum operating time, and operate the gas burner using a closed loop feedback control algorithm for the minimum operating time.

### FIELD OF THE INVENTION

The present subject matter relates generally to oven appliances, and more particularly, to methods of operating heating elements in oven appliances.

### BACKGROUND OF THE INVENTION

Conventional residential and commercial oven appliances generally include a cabinet that includes a cooking chamber for receipt of food items for cooking. Multiple heating elements are positioned within the cooking chamber to provide heat to food items located therein. The heating elements can include, for example, radiant heating elements, such as a bake heating assembly positioned at a bottom of the cooking chamber and/or a separate broiler heating assembly positioned at a top of the cooking chamber.

Oven appliances, whether having gas burners or electric heating elements, have conventionally relied on hysteretic operation of the heating elements. In this regard, conventional appliances operated heating elements for fixed on time based on temperature feedback received from a temperature sensor, e.g., such as a resistance temperature detector (“RTD”). However, rapid ON/OFF cycling of gas burners does not allow the flame and combustion to fully develop for a burner and introduces high cycling usage of the hot surface ignition system (e.g., the glow bar). Other control algorithms may be used, but these algorithms often suffer from inconsistencies or lack of robustness in the cooking cycle. In addition, conventional control algorithms suffer from lack of rapid heat recovery, particularly after long door openings.

Accordingly, an oven appliance that includes features that improved cooking robustness and consistency would be useful. More particularly, a heating element control algorithm that provides for rapid heat recovery and improved steady state temperature control would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, an oven appliance defining a vertical, a lateral, and a transverse direction is provided, including a cooking chamber, a gas burner thermally coupled to the cooking chamber, a temperature sensor in thermal communication with the cooking chamber, and a controller in operative communication with the gas burner and the temperature sensor. The controller is configured to obtain a chamber temperature using the temperature sensor, determine that heat is needed based on the chamber temperature and a target chamber temperature, obtain a target operating time of the gas burner based on the chamber temperature and the target chamber temperature, determine that the target operating time is less than a minimum operating time, and operate the gas burner using a closed loop feedback control algorithm for the minimum operating time.

In another exemplary embodiment, a method of operating an oven appliance is provided. The oven appliance includes a cooking chamber, a gas burner thermally coupled to the cooking chamber, and a temperature sensor in thermal communication with the cooking chamber. The method includes obtaining a chamber temperature using the temperature sensor, determining that heat is needed based on the chamber temperature and a target chamber temperature, obtaining a target operating time of the gas burner based on the chamber temperature and the target chamber temperature, determining that the target operating time is less than a minimum operating time, and operating the gas burner using a closed loop feedback control algorithm for the minimum operating time.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front view of an oven appliance according to an example embodiment of the present subject matter.

FIG. 2 is a perspective, cross-sectional view of the example oven appliance of FIG. 1, taken along Line 2-2 in FIG. 1.

FIG. 3 is a side, cross-sectional view of the example oven appliance of FIG. 1, taken along Line 2-2 in FIG. 1.

FIG. 4 provides a method of operating an oven appliance according to an exemplary embodiment of the present subject matter.

FIG. 5 provides a plot of an oven appliance operating using a closed loop feedback control algorithm according to an exemplary embodiment of the present subject matter.

FIG. 6 provides a method of operating an oven appliance according to an exemplary embodiment of the present subject matter.

FIG. 7 provides a method of operating an oven appliance according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

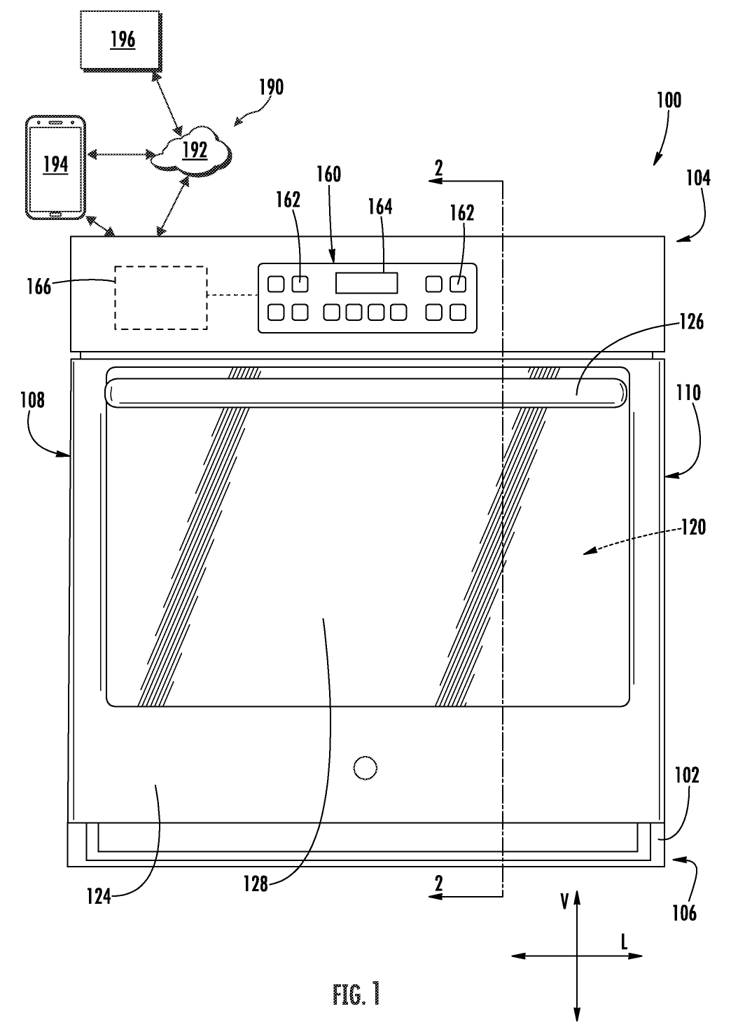

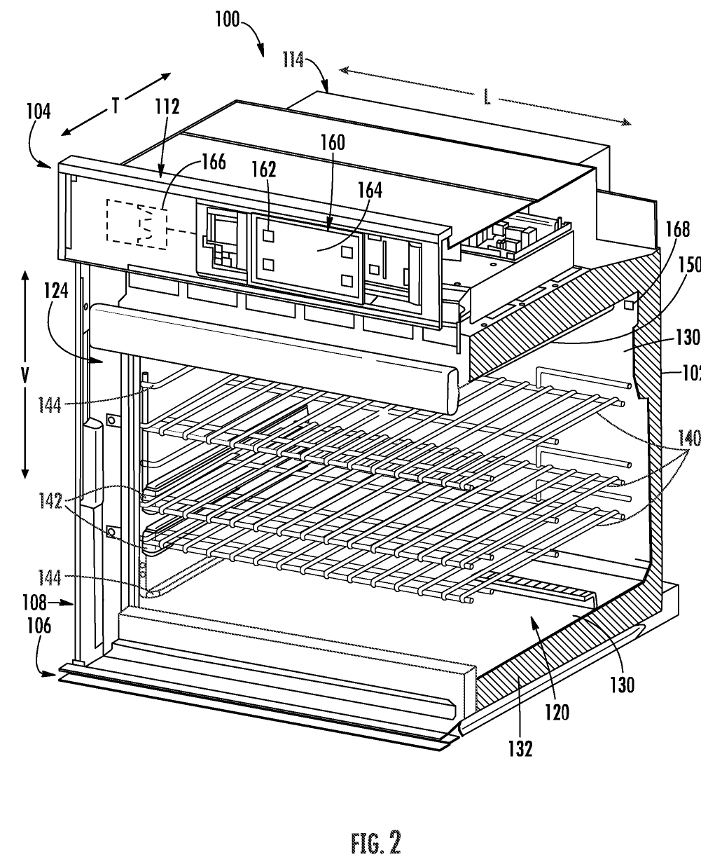

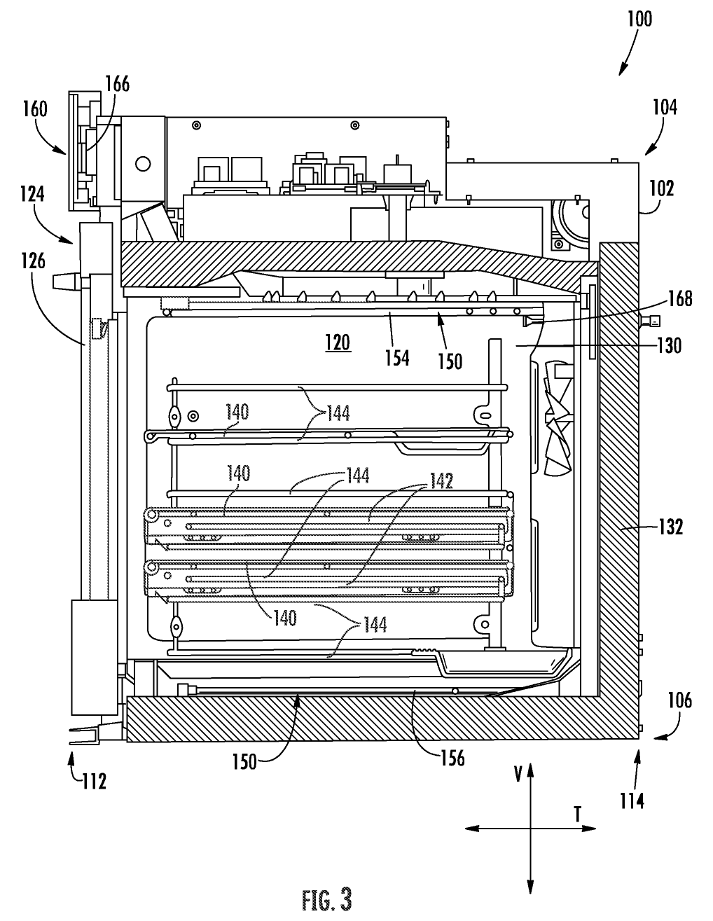

FIG. 1 provides a front view of an oven appliance 100 as may be employed with the present subject matter. In addition, FIGS. 2 and 3 provide perspective and side cross-sectional views, respectively, of oven appliance 100. As shown, oven appliance 100 generally defines a vertical direction V, a lateral direction L, and a transverse direction T, each of which is mutually perpendicular, such that an orthogonal coordinate system is generally defined. As illustrated, oven appliance 100 includes an insulated cabinet 102. Cabinet 102 of oven appliance 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

Within cabinet 102 is a single cooking chamber 120 which is configured for the receipt of one or more food items to be cooked. However, it should be appreciated that oven appliance 100 is provided by way of example only, and aspects of the present subject matter may be used in any suitable cooking appliance, such as a gas or electric double oven range appliance. For example, although oven appliance 100 is illustrated as a wall oven installed within a bank of cabinets, it should be appreciated that aspects of the present subject matter may be used in free-standing oven appliances, double ovens, etc. Moreover, aspects of the present subject matter may be used in any other consumer or commercial appliance where it is desirable to use a rotisserie within another suitable appliance. Thus, the example embodiment shown in FIGS. 1 through 3 is not intended to limit the present subject matter to any particular cooking chamber configuration or arrangement.

Oven appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

In general, cooking chamber 120 is defined by a plurality of chamber walls 130 (FIGS. 2 and 3). Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, oven appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

Referring now to FIG. 3, oven appliance 100 may include a plurality of racks 140 positioned within cooking chamber 120 for receiving food or cooking utensils containing food items. Racks 140 provide support for such food during a cooking process. According to the illustrated embodiment, racks 140 may be slidably mounted within cooking chamber 120 by one or more slide assemblies 142 that are mounted to a sidewall 130 of cooking chamber 120. Alternatively, racks 140 may be slidably received onto embossed ribs or sliding rails such that racks 140 may be conveniently moved into and out of cooking chamber 120.

As best shown in FIG. 3, oven appliance may include six rack supports 144 that are spaced apart along the vertical direction V. In addition, oven appliance 100 is illustrated as including three racks 140 that may each be slidably positioned on each of the six rack supports 144, such that six total rack positions are possible within cooking chamber 120. However, it should be appreciated that according to alternative embodiments, any suitable number of racks mounted in cooking chamber 120 in any suitable manner and being movable between any suitable number of positions is possible and within the scope of the present subject matter.

Oven appliance may further include one or more heating elements (identified generally by reference numeral 150) positioned within cabinet 102 or may otherwise be in thermal communication with cooking chamber 120 for regulating the temperature within cooking chamber 120. For example, heating elements 150 may be electric resistance heating elements, gas burners, microwave heating elements, halogen heating elements, or suitable combinations thereof. According to an exemplary embodiment, oven appliance 100 is a self-cleaning oven. In this regard, heating elements 150 may be configured for heating cooking chamber 120 to a very high temperature (e.g., 800°F or higher) in order to burn off any food residue or otherwise clean cooking chamber 120.

Specifically, an upper gas or electric heating element 154 (also referred to as a broil heating element or gas burner) may be positioned in cabinet 102, e.g., at a top portion of cooking chamber 120, and a lower gas or electric heating element 156 (also referred to as a bake heating element or gas burner) may be positioned at a bottom portion of cooking chamber 120. Upper heating element 154 and lower heating element 156 may be used independently or simultaneously to heat cooking chamber 120, perform a baking or broil operation, perform a cleaning cycle, etc. The size and heat output of heating elements 154, 156 can be selected based on the, e.g., the size of oven appliance 100 or the desired heat output. Oven appliance 100 may include any other suitable number, type, and configuration of heating elements 150 within cabinet 102. For example, oven appliance 100 may further include electric heating elements, induction heating elements, or any other suitable heat generating device.

A user interface panel 160 is located within convenient reach of a user of the oven appliance 100. For this example embodiment, user interface panel 160 includes user inputs 162 that may generally be configured for regulating heating elements 150 or operation of oven appliance 100. In this manner, user inputs 162 allow the user to control operation of oven appliance 100. Although shown with user inputs 162, it should be understood that user inputs 162 and the configuration of oven appliance 100 shown in FIG. 1 is provided by way of example only. More specifically, user interface panel 160 may include various input components, such as one or more of a variety of touch-type controls, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element 150 is activated and/or the rate at which the heating element 150 is set.

Generally, oven appliance 100 may include a controller 166 in operative communication with user interface panel 160. User interface panel 160 of oven appliance 100 may be in communication with controller 166 via, for example, one or more signal lines or shared communication busses, and signals generated in controller 166 operate oven appliance 100 in response to user input via user inputs 162. Input/Output ("I/O") signals may be routed between controller 166 and various operational components of oven appliance 100 such that operation of oven appliance 100 can be regulated by controller 166. In addition, controller 166 may also be communication with one or more sensors, such as temperature sensor 168 (FIG. 2), which may be used to measure temperature inside cooking chamber 120 and provide such measurements to the controller 166. Although temperature sensor 168 is illustrated at a top and rear of cooking chamber 120, it should be appreciated that other sensor types, positions, and configurations may be used according to alternative embodiments.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Referring still to FIG. 1, a schematic diagram of an external communication system 190 will be described according to an exemplary embodiment of the present subject matter. In general, external communication system 190 is configured for permitting interaction, data transfer, and other communications between and among oven appliance 100 and/or a user of oven appliance 100. For example, this communication may be used to provide and receive operating parameters, cycle settings, performance characteristics, user preferences, or any other suitable information for improved performance of oven appliance 100. In addition, external communication system 190 may be used to transfer images or video to a user of oven appliance 100.

External communication system 190 permits controller 166 of oven appliance 100 to communicate with external devices either directly or through a network 192. For example, a consumer may use a consumer device 194 to communicate directly with oven appliance 100. Alternatively, these appliances may include user interfaces for receiving such input (described below). For example, consumer devices 194 may be in direct or indirect communication with oven appliance 100, e.g., directly through a local area network (LAN), Wi-Fi, Bluetooth, Zigbee, etc. or indirectly through network 192. In general, consumer device 194 may be any suitable device for providing and/or receiving communications, displaying images or video, or receiving commands from a user. In this regard, consumer device 194 may include, for example, a personal phone, a tablet, a laptop computer, or another mobile device.

In addition, a remote server 196 may be in communication with oven appliance 100 and/or consumer device 194 through network 192. In this regard, for example, remote server 196 may be a cloud-based server 196, and is thus located at a distant location, such as in a separate state, country, etc. In general, communication between the remote server 196 and the client devices may be carried via a network interface using any type of wireless connection, using a variety of communication protocols (e.g. TCP/IP, HTTP, SMTP, FTP), encodings or formats (e.g. HTML, XML), and/or protection schemes (e.g. VPN, secure HTTP, SSL).

In general, network 192 can be any type of communication network. For example, network 192 can include one or more of a wireless network, a wired network, a personal area network, a local area network, a wide area network, the internet, a cellular network, etc. According to an exemplary embodiment, consumer device 194 may communicate with a remote server 196 over network 192, such as the internet, to provide user inputs, transfer operating parameters or performance characteristics, cycle authorizations, display images or video, etc. In addition, consumer device 194 and remote server 196 may communicate with oven appliance 100 to communicate similar information.

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more oven or cooking appliances, other communication protocols and steps may be implemented, etc. These variations and modifications are contemplated as within the scope of the present subject matter.

Now that the construction of oven appliance 100 and heating elements 150 have been described according to example embodiments of the present subject matter, an exemplary method 200 of operating heating elements in an oven appliance will be described. Although the discussion below refers to the exemplary method 200 of operating heating elements 150 of oven appliance 100, one skilled in the art will appreciate that the exemplary method 200 is applicable to the operation of a variety of other cooking appliances and heating elements types, configurations, etc.

In exemplary embodiments, the various method steps as disclosed herein may be performed by controller 166 or a separate, dedicated controller. In this regard, as described herein, controller 166 of oven appliance 100 may implement all steps of method 200. However, it should be appreciated that according to alternative embodiments, controller 166 may offload the performance of steps described herein, e.g., by communicating with a network or a remote server. Other distributed computing arrangements are possible and within the scope of the present subject matter.

As explained briefly above, oven appliances commonly include gas burners that rely on hysteretic operation of the heating elements, e.g., using fixed on times based on temperature feedback received from a temperature sensor, since rapid ON/OFF cycling of gas burners does not allow the flame and combustion to fully develop for a gas burner and introduces high cycling usage of the hot surface ignition system (e.g., the glow bar). Other control algorithms may be used, but these algorithms often suffer from inconsistencies or lack of robustness in the cooking cycle. In addition, conventional control algorithms suffer from lack of rapid heat recovery, particularly after long door openings. Accordingly, aspects of the present subject matter are generally directed to methods for regulating the operation of heating elements for improved appliance operation.

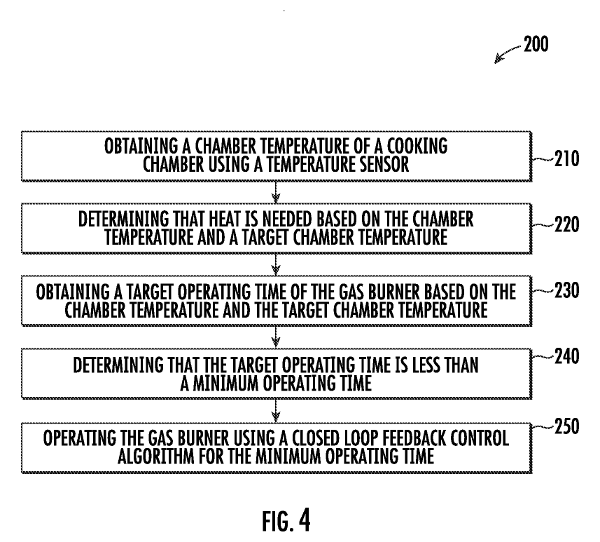

Specifically, referring now to FIG. 4, method 200 includes, at step 210, obtaining a chamber temperature of a cooking chamber using a temperature sensor that is thermally coupled to the cooking chamber. In this regard, continuing the example from above, temperature sensor 168 may continuously or periodically sample or obtain the chamber temperature within cooking chamber 120 and controller 166 may use this temperature feedback to regulate operation of heating elements 150 for improved appliance operation. It should be appreciated that temperature measurements may be obtained at any suitable frequency and/or at any location from which the chamber temperature may be deduced.

Step 220 includes determining that heat is needed based on the chamber temperature and a target chamber temperature. In this regard, the chamber temperature (e.g., obtained at step 210) may be used to determine when and how heating elements should be operated, e.g., particularly based on the target chamber temperature. In this regard, the target chamber temperature may be a set point temperature selected by a user (e.g., such as 400° Fahrenheit) for a cooking operation. According to alternative embodiments, the target chamber temperature may be obtained in any other suitable manner, e.g., based on a preprogrammed cooking recipe, determined by controller 166, etc.

According to example embodiments, the control algorithms that are used to operate heating elements 150 may vary depending on the scenario (e.g., standard call for heat versus call for recovery heat), the type of heating element 150 (e.g., a gas burner versus electric element), the position of the heating element 150 (e.g., top or bottom of cooking chamber 120), etc. Although two exemplary control algorithms are described below, it should be appreciated that aspects of the present subject matter may include additional control algorithms or protocols for operating heating elements 150.

For example, one or more heating elements 150 may be operated using a closed loop feedback control algorithm. In this regard, the power input to the heating element 150 may vary as a function of the target chamber temperature and the actual measured chamber temperature. Specifically, the closed loop feedback control algorithm may operate heating elements 150 to minimize a difference between the measured chamber temperature and a setpoint or target chamber temperature. This error value may act as an input to the closed loop feedback control algorithm which generates a control input that minimizes the error, e.g., such as a heating level or power level.

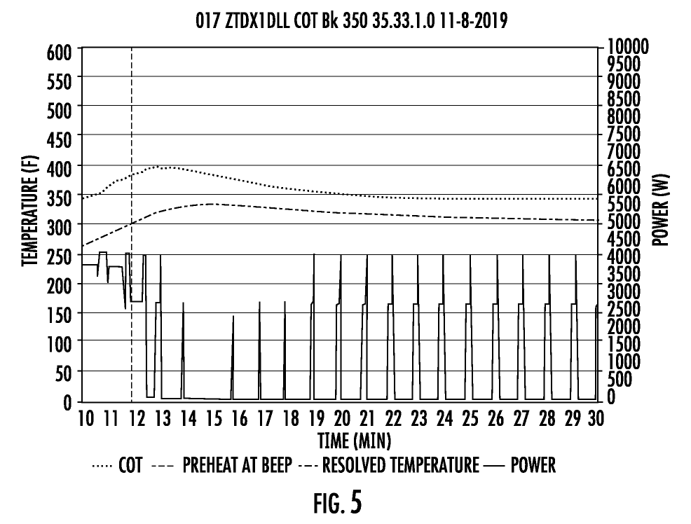

For example, according to exemplary embodiments, the closed loop feedback control algorithm may include a proportional control algorithm, a proportional-integral control algorithm (e.g., a PI controller), or a proportional-integral-derivative control algorithm (e.g., a PID controller). Details regarding the operation of the closed-loop feedback control algorithm are generally well known in the art and further detailed discussion will be omitted here for brevity. It should be appreciated that the algorithm weightings may be adjusted depending on the application. FIG. 5 provides an example of various system parameters when a heating element is operated using a PID control algorithm.

According to example embodiments, the time and quantity of heat applied by heating elements 150 may vary depending on the control algorithm used, the target temperature, the chamber temperature, and other parameters. For example, using a PID control algorithm the quantity of heat may vary based on the error value. By contrast, a hysteretic control algorithm may operate with a fixed on/off time of the heating element over a given time period for as long as the call for heat is still active.

According to an example embodiment, determining that heat is needed based on the chamber temperature and the target chamber temperature may include determining a first temperature threshold based on the target chamber temperature and determining that the chamber temperature has dropped below the first temperature threshold. In this regard, the first temperature threshold may be a predetermined number of degrees below the target chamber temperature, e.g., such as 5°F, 10°F, 20°F, etc. According to alternative embodiments, the first threshold temperature may be a predetermined percentage of the target chamber temperature or may be related to the target chamber temperature using any other suitable algorithm, transfer function, etc. When the first temperature threshold is reached, it may trigger a call for heat in the cooking chamber.

Referring still to FIG. 4, step 230 may include obtaining a target operating time of the gas burner based on the chamber temperature and the target chamber temperature. In this regard, based on the difference between the target chamber temperature and the measured chamber temperature, controller 166 may estimate the amount of time that the gas burner should be operated to heat cooking chamber 120 to the desired temperature or a temperature where there is no longer a call for heat. This target operating time may also vary based on the target temperature, historical heating times, system parameters, and other variables.

Step 240 includes determining that the target operating time is less than a minimum operating time. According to an example embodiment, the minimum operating time may be selected based on a time that is needed to establish a stable flame at the gas burner. This minimum operating time may be preset by the manufacturer, determined by controller 166, or obtained in any other suitable manner.

Step 250 may include operating the gas burner using a closed loop feedback control algorithm for the minimum operating time. In this regard, because the target operating time is less than the minimum operating time needed to facilitate proper gas burner operation, the actual operating time may be adjusted to the minimum operating time, thereby facilitating stable combustion and proper burner operation. For example, in response to receiving a call for heat, the gas burner may be operated using a PID control algorithm with an error between the target chamber temperature and the actual chamber temperature as an input. The output of the closed PID control algorithm may be a fuel flow rate that controller 166 may use to regulate operation of the gas burner. According to an example embodiment, method 200 may further include determining that the target operating time is equal to or greater than the minimum operating time and operating the gas burner using the closed loop feedback control algorithm for the target operating time.

Method 200 may also include operating multiple heating elements in parallel to heat cooking chamber 120. For example, oven appliance may include an auxiliary heating element, e.g., a gas burner or electric heating element, that is operated using hysteretic control or closed loop control (e.g., a PID controller). For example, is the auxiliary heating element is a second gas burner operated under PID control, method 200 may include obtaining a second target operating time of the second gas burner based on the chamber temperature and the target chamber temperature, determining that the second target operating time is less than a second minimum operating time, and operating the second gas burner using a closed loop feedback control algorithm for the second minimum operating time. It should be appreciated that the second target operating time may be the same as or different than the target operating time associated with the other gas burner, e.g., based on burner characteristics, positioning, operating expectations, etc. Alternatively, the auxiliary heating element may be an electric heating element that is operated using a closed loop feedback control algorithm.

According to example embodiments, method 200 may further include determining that heat is no longer needed based on the chamber temperature and the target chamber temperature and turning off the gas burner or other heating elements. For example, determining that heat is no longer needed based on the chamber temperature and the target chamber temperature may include determining that the chamber temperature is higher than a second temperature threshold. For example, the second temperature threshold may be a temperature that is equal to the target chamber temperature or a predetermined number of degrees above the target temperature, e.g., such as such as 5°F, 10°F, 20°F, etc. According to alternative embodiments, the second threshold temperature may be a predetermined percentage of the target chamber temperature or may be related to the target chamber temperature using any other suitable algorithm, transfer function, etc. When the second temperature threshold is reached, it may end the call for heat until the first or threshold is reached again.

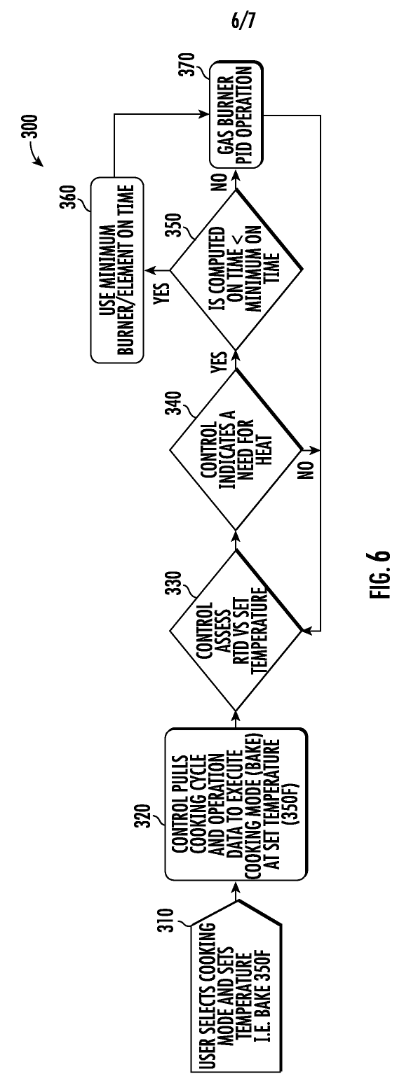

Referring now briefly to FIG. 6, an example flow diagram illustrating a method 300 of heating element operation is provided according to an example embodiment. It should be appreciated that steps of method 300 may be the similar to or interchangeable with steps of method 200 described above. As shown, step 310 includes initiating a cooking cycle, e.g., in response to receiving a user input that includes a cooking mode and temperature setpoint or target chamber temperature. For example, a user may select a bake mode at 350°F, an air fry operation at 450°F, a broil operation at 500°F, etc. Step 320 may include using the appliance controller to operate the heating elements and execute the cooking cycle.

Step 330 may include comparing the measured chamber temperature to the target chamber temperature. For example, a resistance temperature detector (“RTD”) may be used to obtain the chamber temperature. Step 340 may include determining whether there is a call for heat based on the measured and target temperatures. If there is a call for heat (e.g., the chamber temperature has fallen below a trigger threshold or a first temperature threshold), step 350 may include determining whether the computed on time of the gas burner falls below a minimum on time needed to establish a stable flame and proper combustion. If the computed on time is less than the minimum on time, step 360 includes using the minimum on time and step 370 includes operating the gas burner using a PID control algorithm for the minimum on time. By contrast, if step 350 results in a determination that the computed on time is not less than the minimum on time, step 370 includes operating the gas burner using a PID control algorithm for the computed on time.

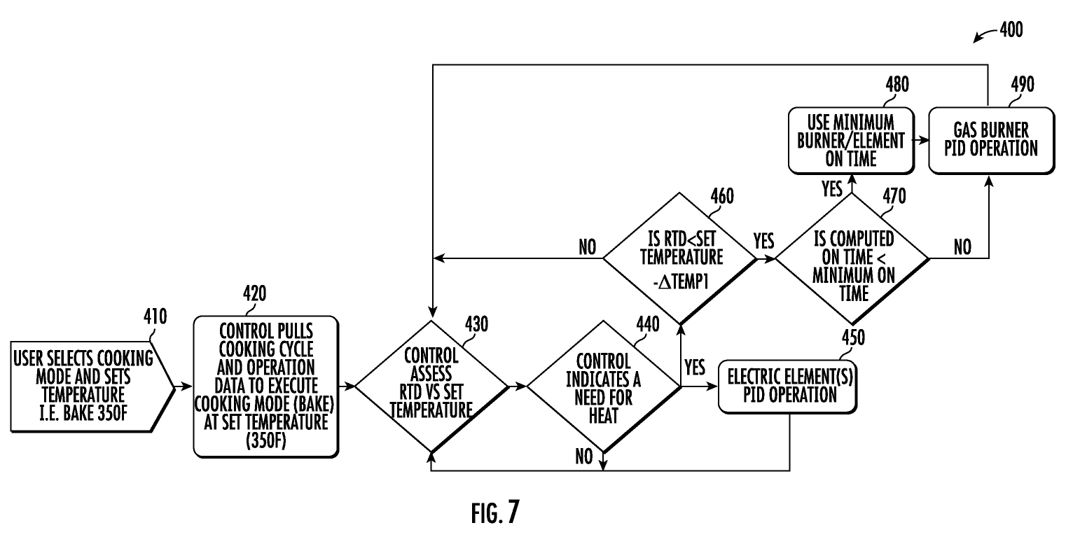

Referring now briefly to FIG. 7, an example flow diagram illustrating a method 400 of heating element operation is provided according to an example embodiment. It should be appreciated that steps of method 400 may be the similar to or interchangeable with steps of methods 200 and 300 described above. As shown, step 410 includes initiating a cooking cycle, e.g., in response to receiving a user input that includes a cooking mode and temperature setpoint or target chamber temperature. For example, a user may select a bake mode at 350°F, an air fry operation at 450°F, a broil operation at 500°F, etc. Step 420 may include using the appliance controller to operate the heating elements and execute the cooking cycle.

Step 430 may include comparing the measured chamber temperature to the target chamber temperature. For example, a resistance temperature detector (“RTD”) may be used to obtain the chamber temperature. Step 440 may include determining whether there is a call for heat based on the measured and target temperatures. If there is a call for heat (e.g., the chamber temperature has fallen below a trigger threshold or a first temperature threshold), step 450 may include operating the first heating element (e.g., an electric heating element) using a PID control algorithm. In addition, if there is a call for heat, step 460 may include determining whether the chamber temperature has fallen a predetermined amount below the target temperature (e.g., the first threshold temperature as described above). If the chamber temperature is below the first temperature threshold, the second heating element (e.g., the gas burner) may be operated using a PID control algorithm, where steps 470, 480, and 490 are the same as steps 350, 360, and 370, respectively.

FIGS. 4, 6, and 7 depict steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of methods 200, 300, and 400 are explained using oven appliance 100 and heating elements 150 as an example, it should be appreciated that this method may be applied to the operation of any heating elements in any cooking appliance.

As explained herein, aspects of the present subject matter are generally directed to a cooking algorithm that provides proportional-integral-derivative (“PID”) operation of a gas burner. The cooking algorithm may have the ability to execute PID operation with a minimum ON time during the period, which allows the gas system to execute the PID operation with a minimum ON time to support combustion and development of the burner flame.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance defining a vertical, a lateral, and a transverse direction, the oven appliance comprising:
a cooking chamber;
a gas burner thermally coupled to the cooking chamber;
a temperature sensor in thermal communication with the cooking chamber; and
a controller in operative communication with the gas burner and the temperature sensor, the controller being configured to:
obtain a chamber temperature using the temperature sensor;
determine that heat is needed based on the chamber temperature and a target chamber temperature;
obtain a target operating time of the gas burner based on the chamber temperature and the target chamber temperature;
determine that the target operating time is less than a minimum operating time; and
operate the gas burner using a closed loop feedback control algorithm for the minimum operating time.

2. The oven appliance of claim 1, wherein the controller is further configured to:
determine that the target operating time is equal to or greater than the minimum operating time; and
operate the gas burner using the closed loop feedback control algorithm for the target operating time.

3. The oven appliance of claim 1, wherein the minimum operating time is selected based on a time needed to establish a flame at the gas burner.

4. The oven appliance of claim 1, wherein the gas burner is a first gas burner and the oven appliance further comprises a second gas burner thermally coupled to the cooking chamber, the controller further being configured to:
obtain a second target operating time of the second gas burner based on the chamber temperature and the target chamber temperature;
determine that the second target operating time is less than a second minimum operating time; and
operate the second gas burner using a closed loop feedback control algorithm for the second minimum operating time.

5. The oven appliance of claim 4, wherein the minimum operating time is different than the second minimum operating time.

6. The oven appliance of claim 1, wherein the oven appliance further comprises an electric heating element thermally coupled to the cooking chamber, the controller further being configured to:
operate the electric heating element in parallel with the gas burner using a closed loop feedback control algorithm.

7. The oven appliance of claim 1, wherein determining that heat is needed based on the chamber temperature and the target chamber temperature comprises:
determining a first temperature threshold based on the target chamber temperature; and
determining that the chamber temperature has dropped below the first temperature threshold.

8. The oven appliance of claim 1, wherein the controller is further configured to:
determine that heat is no longer needed based on the chamber temperature and the target chamber temperature; and
turn off the gas burner.

9. The oven appliance of claim 8, wherein determining that heat is no longer needed based on the chamber temperature and the target chamber temperature comprises:
determining a second temperature threshold based on the target chamber temperature; and
determining that the chamber temperature is higher than the second temperature threshold.

10. The oven appliance of claim 1, wherein the closed loop feedback control algorithm comprises a proportional control algorithm, a proportional-integral control algorithm, or a proportional-integral-derivative control algorithm.

11. A method of operating an oven appliance, the oven appliance comprising a cooking chamber, a gas burner thermally coupled to the cooking chamber, and a temperature sensor in thermal communication with the cooking chamber, the method comprising:
obtaining a chamber temperature using the temperature sensor;
determining that heat is needed based on the chamber temperature and a target chamber temperature;
obtaining a target operating time of the gas burner based on the chamber temperature and the target chamber temperature;
determining that the target operating time is less than a minimum operating time; and
operating the gas burner using a closed loop feedback control algorithm for the minimum operating time.

12. The method of claim 11, further comprising:
determining that the target operating time is equal to or greater than the minimum operating time; and
operating the gas burner using the closed loop feedback control algorithm for the target operating time.

13. The method of claim 11, wherein the minimum operating time is selected based on a time needed to establish a flame at the gas burner.

14. The method of claim 11, wherein the gas burner is a first gas burner and the oven appliance further comprises a second gas burner thermally coupled to the cooking chamber, the method further comprising:
obtaining a second target operating time of the second gas burner based on the chamber temperature and the target chamber temperature;
determining that the second target operating time is less than a second minimum operating time; and
operating the second gas burner using a closed loop feedback control algorithm for the second minimum operating time.

15. The method of claim 14, wherein the minimum operating time is different than the second minimum operating time.

16. The method of claim 11, wherein the oven appliance further comprises an electric heating element thermally coupled to the cooking chamber, the method further comprising:
operating the electric heating element in parallel with the gas burner using a closed loop feedback control algorithm.

17. The method of claim 11, wherein determining that heat is needed based on the chamber temperature and the target chamber temperature comprises:
determining a first temperature threshold based on the target chamber temperature; and
determining that the chamber temperature has dropped below the first temperature threshold.

18. The method of claim 11, further comprising:
determining that heat is no longer needed based on the chamber temperature and the target chamber temperature; and
turning off the gas burner.

19. The method of claim 18, wherein determining that heat is no longer needed based on the chamber temperature and the target chamber temperature comprises:
determining a second temperature threshold based on the target chamber temperature; and
determining that the chamber temperature is higher than the second temperature threshold.

20. The method of claim 11, wherein the closed loop feedback control algorithm comprises a proportional control algorithm, a proportional-integral control algorithm, or a proportional-integral-derivative control algorithm.
